(19) United States
(12) Patent Application Publication
(10) Pub. No.: US 2023/0365047 A1
(43) Pub. Date: Nov. 16, 2023

(54) System and Method for Providing Convenience Items by Mobile Truck

(71) Applicants: Essence Stiger, Victorville, CA (US); Brandi Voronyak, Victorville, CA (US)

(72) Inventors: Essence Stiger, Victorville, CA (US); Brandi Voronyak, Victorville, CA (US)

(21) Appl. No.: 18/314,857

(22) Filed: May 10, 2023

Related U.S. Application Data
(60) Provisional application No. 63/340,032, filed on May 10, 2022.

(51) Int. Cl. B60P 3/025; G07F 9/02; G07F 9/00

(52) U.S. Cl. CPC B60P 3/0257; G07F 9/023; G07F 9/006

(57) ABSTRACT

The present invention relates to a mobile general store truck and a system for purchasing and accessing convenience items at the mobile general store truck. The store truck is configured to store different food items, beverages, tobacco, and more that can be ordered by customers at the store truck or by using a website or application. The ordered items are accessible at a scheduled time and place to customers by the store truck. In some embodiments, the truck can be a part of a fleet in which a truck in the delivery range of the customer provides the items. The invention enables the customers to order and have the items accessible or provided as per their convenience and thus saving time and effort in purchasing convenience items.

### CROSS-REFERENCE TO RELATED APPLICATION

The present application claims priority to, and the benefit of, U.S. Provisional Application No. 63/340,032, which was filed on May 10, 2022, and is incorporated herein by reference in its entirety.

### FIELD OF THE INVENTION

The present invention relates generally to the field of convenience and grocery stores. More specifically, the present invention relates to a general store located within a mobile truck, enabling customers to be reached anywhere. The invention provides a business method of selling various goods, similar to a general store, inside the mobile truck. The customers can order items via a website or an application, as well as schedule delivery as per their preferences. The invention saves time and effort when purchasing items typically found in convenience and general stores. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals regularly require food items, beverages, and other convenience items. Generally, individuals go to convenience stores to buy such items. However, many individuals cannot drive and have difficulty in travelling and therefore, find it difficult to travel to convenience stores. Such individuals commonly find themselves without food, beverages, tobacco etc., which is not only discomforting, but also frustrating and embarrassing in front of others. Individuals desire a way that enables them to conveniently have general store items at locations of their preference or brought to their preferred locations.

Convenience stores are expensive and for buying small items, transportation costs are expensive. Individuals try to avoid going to such stores because of increased traffic and lack of convenience as well. Therefore, individuals desire a way by which they can purchase items in an expedient and cost-effective manner.

Therefore, there exists a long-felt need in the art for a system that enables customers to easily purchase and receive grocery and other convenience items. There is also a long-felt need in the art for a system and method that enables individuals to receive goods at their desired time and desired location. Additionally, there is a long-felt need in the art for a business method that enables individuals to purchase goods from their home or near one's home. Moreover, there is a long-felt need in the art for a business method that saves time and effort of customers for purchasing grocery and other items. Further, there is a long-felt need in the art for a method that is useful for individuals having difficulty in travelling for ordering and receiving convenience items. Finally, there is a long-felt need in the art for a business method that offers different locations for purchasing convenience items and saves time and effort of individuals typically found in general and convenience stores.

The subject matter disclosed and claimed herein, in one embodiment thereof, comprises a method of storing and selling different items, similar to a general store, inside and from a mobile truck. The method is configured to provide a plurality of purchasing locations for customers and includes the steps of storing different items including at least grocery items, beverages, tobacco, et. al., in the mobile truck; receiving, from a customer, an order of items stored in the mobile truck; receiving, from the customer, a payment for the ordered items; and delivering, to the customer, ordered items from the mobile truck. The customer can order items via a website or an application or by interfacing with the mobile truck directly.

In this manner, the business method of the present invention accomplishes all of the forgoing objectives and provides users with a business method of selling various goods, similar to a general store, inside and from a mobile truck. The method enables individuals to purchase directly from the truck or have the items delivered at a scheduled location at a scheduled time. The method and associated system save time and effort when purchasing items typically found in convenience and general stores.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a mobile general store. The mobile general store is in the form a truck and further comprising a pair of sidewalls, a rear end wall and a roof; an internal area for storing a plurality of items in an organized manner; a plurality of digital icons disposed on an exterior surface of the truck indicating the items available in the truck; a display device for displaying items ordered by a customer; an indicia, and a website URL printed on the exterior surface, wherein a customer visits the mobile general store and purchases items stored therein.

In yet another embodiment, the truck is a self-driving truck.

In yet another embodiment, the truck is an electric truck or a gasoline truck.

In yet another embodiment, the ordered items are retrieved by an attendant of the truck or by a robot system.

In yet another embodiment, a method of storing and selling different items, similar to a general store, inside a mobile truck is described. The method includes the steps of storing different items, including at least grocery items, beverages, tobacco in the mobile truck; receiving, from a customer, an order of items store in the mobile truck; receiving, from the customer, a payment for the ordered items; and delivering, to the customer, ordered items from the mobile truck.

In yet another embodiment, a computer-implemented method for dynamically presenting ecommerce webpages based on items stored in a mobile grocery store truck for ordering items is described. The method comprising the steps of storing, in an inventory database, information of items stored in the truck; displaying, by a website or an application, items stored in the inventory database; receiving, by a server providing the webpages, an order of one or more items from a customer via the website/application; delivering, by the store truck, ordered items at a scheduled time and location to the customer.

In yet another embodiment, a method of a mobile truck travelling to a location to deliver items ordered by a customer is described. The method comprising the steps of receiving an order from the customer; receiving a scheduled time and location from the customer; notifying the mobile truck of the scheduled time and location along with the order and customer information; mobile truck travelling to the scheduled location at the scheduled time to deliver the items after authenticating the customer.

In yet another embodiment, the method further comprising the step of notifying another mobile truck in a delivery range of the customer for delivering the ordered items at scheduled location at scheduled time.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a mobile general store truck of the present invention in accordance with the disclosed architecture;

FIG. 2 illustrates a schematic diagram of a connection of the mobile shop with webservers enabling customers and mobile shop owners to interact and transact electronically in accordance with the disclosed architecture;

FIG. 3 illustrates a block diagram describing essential modules and databases of the server system for providing functionality of purchasing items via application or website in accordance with the disclosed architecture;

FIG. 4 illustrates a schematic diagram showing a flow diagram of purchasing items by customers from the mobile shop of the present invention in accordance with the disclosed architecture;

FIG. 5 illustrates an exemplary webpage displayed by the website/application in accordance with the disclosed architecture;

FIG. 6 illustrates another exemplary user interface displayed by the website/application in accordance with the disclosed architecture;

FIG. 7 illustrates a flow diagram depicting a process of purchasing items vending style from the mobile shop in accordance with the disclosed architecture;

FIG. 8 illustrates a flow diagram depicting a process of purchasing items and scheduling delivery in accordance with the disclosed architecture; and

FIG. 9 illustrates a flow diagram depicting a process performed at a mobile general store truck in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there is a long-felt need in the art for a system that enables customers to easily purchase and receive grocery and other convenience items. There is also a long-felt need in the art for a system and method that enables individuals to receive goods at their desired time and desired location. Additionally, there is a long-felt need in the art for a business method that enables individuals to purchase goods from their home. Moreover, there is a long-felt need in the art for a business method that saves time and effort of customers for purchasing grocery and other items. Further, there is a long-felt need in the art for a method that is useful for individuals having difficulty in travelling for ordering and receiving convenience items. Finally, there is a long-felt need in the art for a business method that offers different locations for purchasing convenience and time savings for individuals to purchase items typically found in general and convenience stores.

The present invention, in one exemplary embodiment, is a novel mobile general store. The mobile general store is in the form a truck and further comprising a pair of sidewalls, a rear end wall and a roof; an internal area for storing a plurality of items in an organized manner; a plurality of digital icons disposed on an exterior surface of the truck indicating the items available in the truck; a display device for displaying items ordered by a customer; an indicia and a website URL printed on the exterior surface, wherein a customer visits the mobile general store and purchases items stored therein.

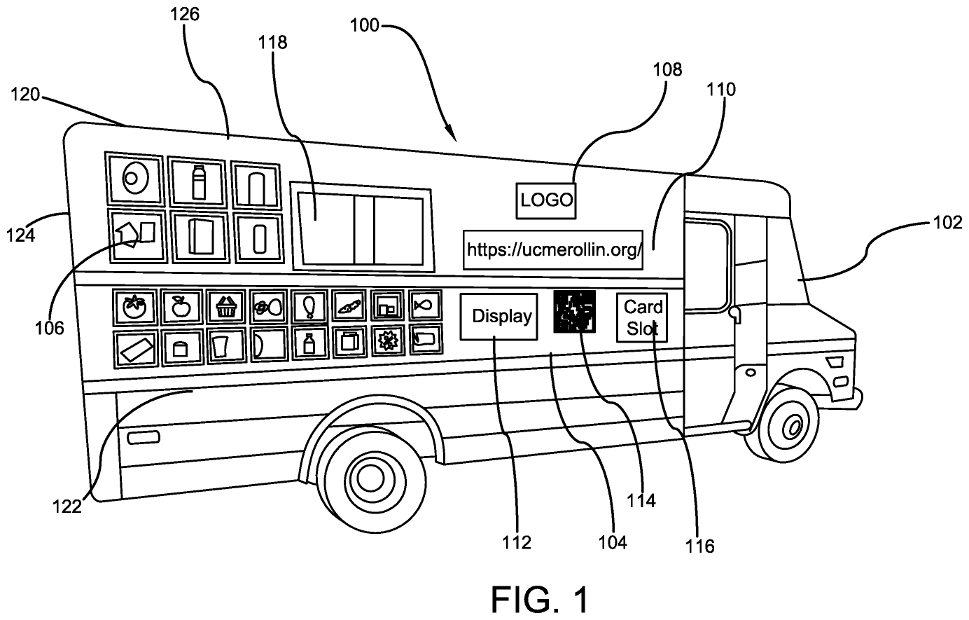

Referring initially to the drawings, FIG. 1 illustrates a perspective view of one potential embodiment of a mobile general store truck of the present invention in accordance with the disclosed architecture. The mobile general store truck 100 is designed as a general store located within a mobile truck, enabling customers to be reached anywhere. The mobile store truck 100 stores various goods or items, such as, food items, beverages, tobacco, household items, and more which can be purchased by customers from the mobile truck 100 or can have the items delivered at a scheduled location.

In one exemplary embodiment, the mobile grocery shop 100 is a Freightliner-type mobile truck 102 that is fully renovated inside to store various general store items. In some embodiments, the mobile shop 100 can accommodate customers inside for physical shopping of items. The mobile truck 100 is configured to regularly change geographic locations and can be available in all areas. The exterior surface 104 of the truck 102 includes a plurality of digital icons 106 configured to indicate the items sold by the mobile shop 100. The exterior surface 104 can further have a Logo 108 for branding or marketing purposes and includes a website URL 110 for accessing a website for ordering items available in the mobile shop 100.

A digital display 112 disposed on the exterior surface 104 is configured to display the ordered items and amount of an order placed by a customer physically at the mobile shop 100. The display 112 can also be configured to display a menu, i.e., similar to a bank ATM, for making a payment for the ordered items. A QR code 114 is configured to be scanned by an imaging device such as a camera of a smartphone and redirects a user to the website hosted on the website URL 110. The QR code 114 is encoded with the website URL 110 and enables users to directly order items from the website or application as discussed in detail later in the disclosure.

A card slot 116 is positioned on the exterior surface 104 for enabling users to use credit cards, debit cards, and more for purchasing items from the mobile shop 100. Also, a window 118 is provided for enabling an attendant of the mobile shop 100 to hand over the ordered goods to the customers. It should be noted that in some embodiments, the mobile shop 100 is robot operated (i.e., autonomous) and does not require any manual intervention for delivering items or goods from the window 118. Further, the mobile shop truck 100 can be a self-driving truck, an autonomous truck, or a robotic truck that requires no human driver.

The mobile shop 100 can be independent or alternatively can be a part of a fleet of similar mobile shops 100. The mobile shop 100 relieves the business owners from fixed costs of brick-and-mortar businesses while providing advantages and exposure of e-commerce through the website and application. Construction wise, the mobile truck 100 includes a left sidewall 120 spaced from a right sidewall 122; a rear end wall 124 extending between the left and right sidewalls; a roof 126; an interior area or interior space for storing items and defined between the left 120 and right sidewalls 122 and below the roof 126. The truck 102 can be made of durable and lightweight metal or alloy and can come in different designs, shapes, and sizes.

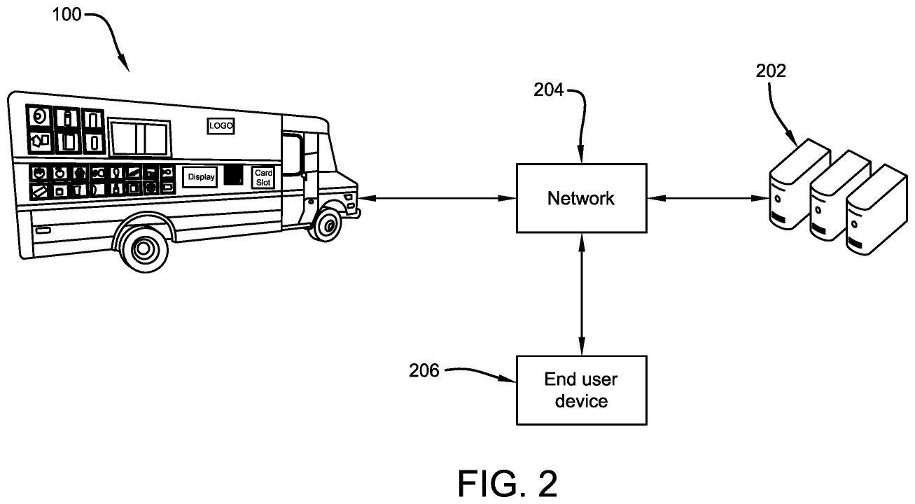

FIG. 2 illustrates a schematic diagram of a connection of the mobile shop 100 with webservers enabling customers and mobile shop owners to interact and transact electronically in accordance with the disclosed architecture. The present invention offers a website or application offered by one or more webservers 202 that enable customers to purchase and schedule delivery of purchased items. The orders are notified to the mobile shop 100 so that the ordered objects can be delivered to customers without any difficulty.

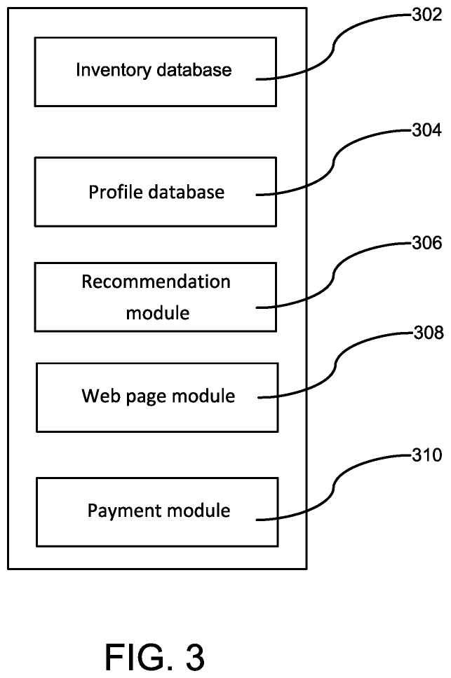

The mobile truck 100 is connected to the webservers 202 enabling the mobile truck 100 to receive orders placed online via a website or application by customers. The webserver 202 can be a cloud server, an application server, a central server, or the like and provides the necessary functionality enabling business through online mode as described in FIG. 3. A public network 204 such as Internet or alternatively a private network is used for connecting the mobile truck 100 and the webserver 202. Further, the customers access the website or application on their electronic or end devices 206 for purchasing items thereby obviating direct contact with the truck 100 for ordering items or objects. The end devices 206 can be a smartphone, laptop, smartwatch, PDA, tablet, or any other device capable of supporting a browser application for accessing a website for purchasing items offered on the mobile shop 100.

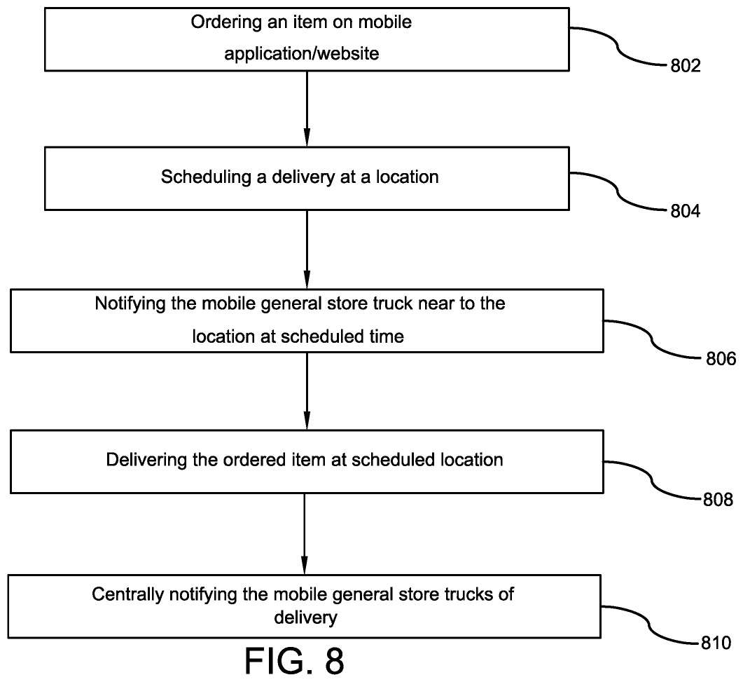

It should be appreciated that the webservers 202 can connect to a fleet of mobile shops within a single city or across cities for overall control and management. Further, a mobile shop can include a location selected by a user for delivery and can include an automatic notification by the server system 202 for delivery or access at a scheduled time as described in FIG. 8.

The communication network 204 may include suitable logic, circuitry, and interfaces that can be configured to provide a plurality of network ports and a plurality of communication channels for transmission and reception of data related to operations of various entities. Each network port may correspond to a virtual address (or a physical machine address) for transmission and reception of the communication data. For example, the virtual address can be an Internet Protocol Version 4 (IPV4) (or an IPV6 address) and the physical address can be a Media Access Control (MAC) address. The communication network 204 can be associated with an application layer for implementation of communication protocols. The communication data can be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

FIG. 3 illustrates a block diagram describing essential modules and databases of the server system 202 for providing functionality of purchasing items via application or website in accordance with the disclosed architecture. An inventory database 302 is used for storing inventory data associated with item(s) offered for sale by the mobile shop 100. When there is a fleet of the mobile shops, then, the inventory database 302 may store inventory data of each mobile shop along with the detail of which item is available in which mobile shop. The information may include for example, a description of an item, a price of the item, a discount available for the item, taxes applicable to the item, a location of the item, image(s) of the item, characteristic(s) of the item, etc.

A profile database 304 is configured to store or save profiles and information of mobile shops 100, their coverage area, and business owner information. Also, information of logged in users can be stored in the profile database 304 that can used for sending recommendations to users. Recommendations can be provided by a recommendation module 306 and may include location specifics of a closest mobile shop 100, recommending new items based on purchase history and more.

A webpage module 308 is used for storing and designing webpages based on the databases of the server system 202. The webpage module 306 dynamically generates and updates the webpages based on inventory information stored in the inventory database 302. A payment module 310 is configured to process payments made by customers on the application and website and also on the point-of-sale (POS), i.e., in person or at the mobile shops.

It should be noted that transaction processing of both point-of-sale customers and online customers are tracked by the server system 202 and items are physically delivered by the mobile shop. Customers can walk to the mobile shop to pick up items or can schedule delivery time at a specific location.

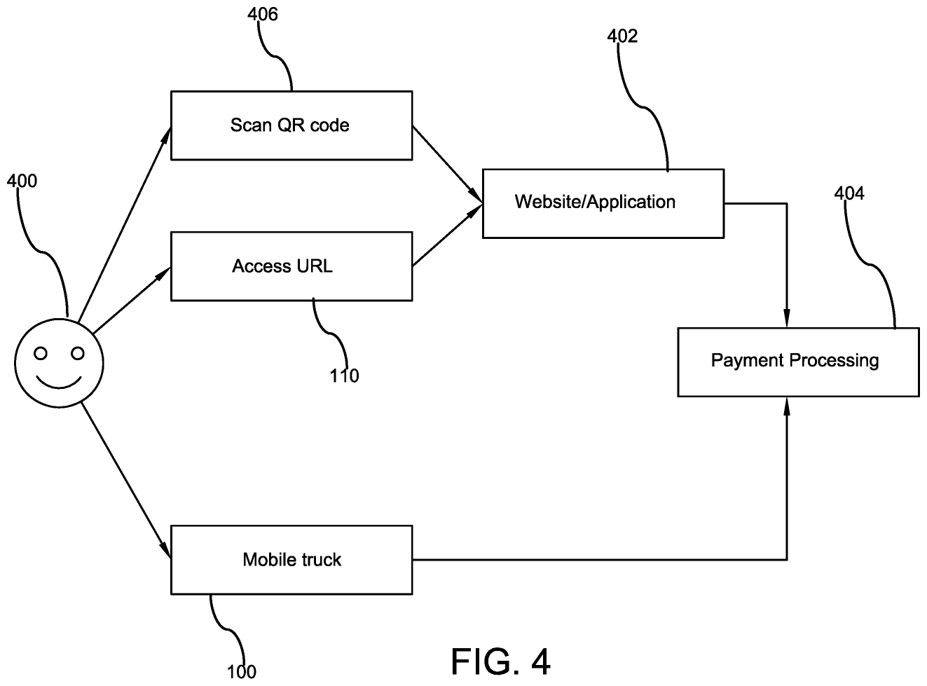

FIG. 4 illustrates a schematic diagram showing flow of purchasing items by customers from the mobile shop of the present invention in accordance with the disclosed architecture. A customer 400 has the options of purchasing an item POS by physically going to the mobile shop or via the application or website. In both of the cases, a mobile shop delivers the items to the customer after processing of payment is made. As illustrated, the customer 400 can visit the website or application 402 by scanning 406 the QR code 114 disposed on an exterior surface of the mobile shop. In the preferred embodiment, when the customer 400 scans the QR code 114, the redirected website 402 displays the items or objects available in that respective mobile shop on which the QR code 114 is printed. A URL 110 can also be used for accessing the website 402 and purchasing items.

The user 400 can also go to a mobile shop 100 to do a POS shopping. The user 400 can be provided an indication of a nearby mobile shop based on the current location of the user 400. When the customer 400 places an order on the website 402 or on a mobile shop POS, the payment is processed 404 and information is stored on the server system 202. Based on the preference of the customer 400, the items are delivered to the customer 400.

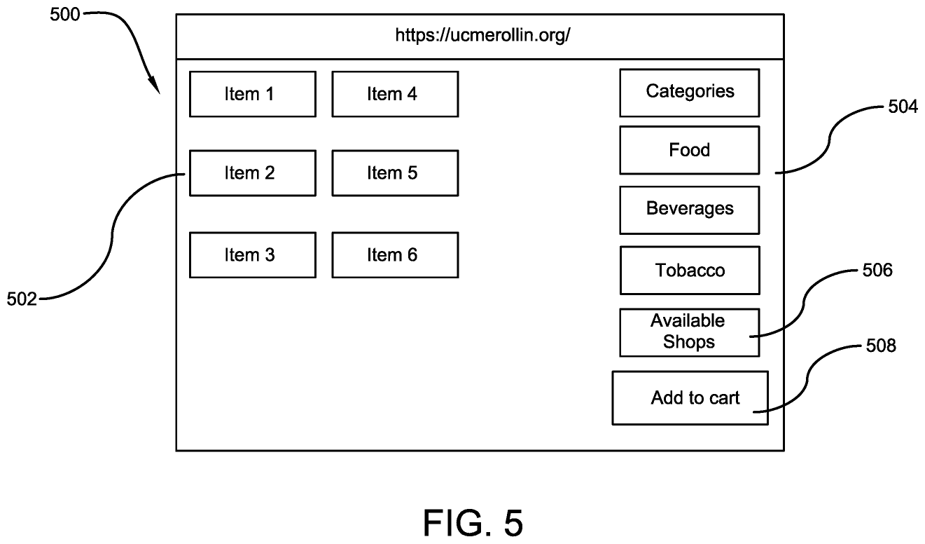

FIG. 5 illustrates an exemplary webpage displayed by the website/application 402 in accordance with the disclosed architecture. As illustrated, the webpage 500 displays a list 502 of items available in the mobile shop. The webpage 500 is scrollable and displays a long list of items available in the mobile shop. The webpage 500 is also configured to display categories 504 such as food, beverages, tobacco and more which can be selected by a customer. An “available shops” button 506 is displayed and is configured to display a plurality of mobile shops that are nearby to a customer using the website. Once the items are selected by the customer, then “Add to Cart” button 508 adds the items to the cart for purchase by the customer.

The webpage 500 or interface is scaled as per display size of an electronic device and is similar in both application and website. Further, the items and categories are updated in real time based on the inventory in the system. Further, additional details such as count of left items, rating by users, price, and other specifications are also displayed on the webpage 500.

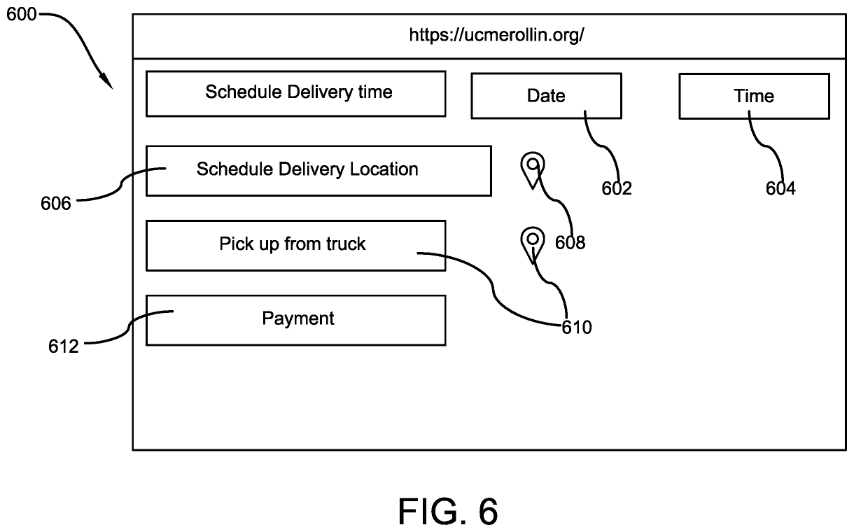

FIG. 6 illustrates another exemplary user interface displayed by the website/application 402 in accordance with the disclosed architecture. As described earlier, a customer can schedule a delivery time and place for delivering ordered items via the website/application. Also, the items can be picked-up by walking to the mobile shop by the customer. Accordingly, while placing the order, a customer can schedule a delivery date and time using the drop-down menus 602, 604 and can set delivery location 606 using the map icon 608. In situations where the user wants to pick-up from the truck shop, the user can select a specific truck shop using the other map icon 610 or simply can walk to the mobile shop upon which the order is placed. Once the delivery preferences are set by the customer, payment can be completed using the payment icon 612 and order is confirmed.

The user interface 600 can display other delivery parameters and other options such as coupons, rewards, and more. Further, in some embodiments, the website/application also provides the feature of digital wallet and any payment method such as credit card, debit card, and more can be used for making a payment by the customer. Once an order is confirmed, a notification can be sent to customer's registered email ID, phone number, and more in the form of an email, push notification, SMS, MMS, instant message, and more.

In some embodiments, the application/website 402 may enable a customer to view new orders, confirm, modify, or reject the orders, enter information about the orders, and so on. Also, in some embodiments, merchant (mobile truck) may confirm an order, reject an order, alter an order, adjust one or more parameters of an order, and so on.

Customers that access the website/application to see items that deliver to a location can be shown information identifying the adjusted delivery area. In some embodiments, the customer can be sent a notice if a mobile truck moves into a delivery range of the user. Some examples of such functionality are discussed herein with respect to user apparitions, but it should be recognized that such functionality may not be limited to user mobility.

The present invention enables a mobile truck's attendant to obtain pictures of customer identification (e.g., drivers licenses). Such identification can be required by some jurisdictions for delivery of certain types of goods. For example, if alcohol is being delivered, a state may require verification of an age of a customer. Accordingly, to verify such age, the attendant may take pictures of customer IDs.

In some embodiments, the mobile truck owner/attendant may have direct contact with a customer. For example, the system may provide a telephone number of the customer. In some embodiments, the attendant or even the customer may initiate a call. Through such contact, pickup and/or delivery details, and so on can be discussed.

Some embodiments may include storing information that associates barcodes with item information stored for the items in the mobile store. Such information can be entered into a computer system of a service by an agent or attendant. For example, in some embodiments, the attendant and/or computer program may scan in a set of barcodes associated with a set of items.

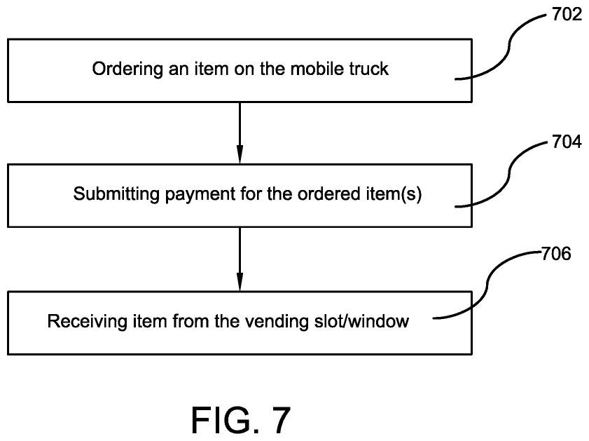

FIG. 7 illustrates a flow diagram depicting a process of purchasing items vending style from the mobile shop 100 in accordance with the disclosed architecture. Initially, a customer orders one or more items on the mobile truck (Step 702). The display of the mobile shop truck may display items for selection and further display icons disposed on the truck. Once selection is done, a payment is completed and confirmed for the ordered items by the customer using POS of the mobile truck (Step 704). Finally, the items are received by the customer from the window or vending slot of the mobile truck (Step 706).

FIG. 8 illustrates a flow diagram depicting a process of purchasing items and scheduling delivery in accordance with the disclosed architecture. Initially, items are ordered and purchased on a mobile application or website (Step 802). The delivery of the items is scheduled by the user as described in FIG. 6 (Step 804). For maintaining efficiency of the system where a plurality of mobile shops is in a fleet, a mobile general store truck having a location near to the scheduled location at the scheduled time is notified for the delivery of the ordered items (Step 806). In situations where there is only one mobile general store truck, then, the truck reaches the scheduled location at the scheduled time.

Accordingly, the ordered items are delivered at the scheduled location at the scheduled time (Step 808). When the mobile general store is a part of a fleet, the other trucks are notified of a successful delivery and the server system centrally updates the delivery of items (Step 810).

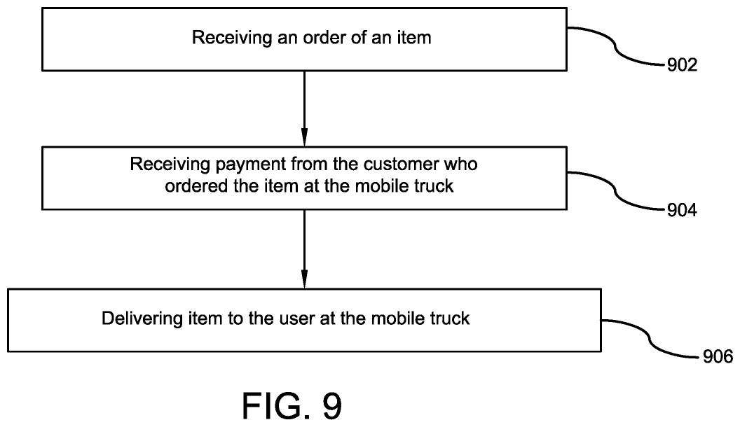

FIG. 9 illustrates a flow diagram depicting a process performed at a mobile general store truck in accordance with the disclosed architecture. Initially, the attendant/robot system of the mobile general store truck receives an order of items from one or more customers (Step 902). Then, a confirmation of the payment is received from the customer (Step 904). Simultaneously, the order information and payment confirmation are stored in the server system for further processing and tracking. Finally, as per the delivery preferences of the user, the ordered items are delivered (Step 906).

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “mobile general store truck”, “mobile shop”, “mobile grocery shop”, “mobile truck”, and “mobile general store” are interchangeable and refer to the mobile general store 100 of the present invention.

Notwithstanding the forgoing, the mobile general store 100 of the present invention can be of any suitable size and configuration as is known in the art without affecting the overall concept of the invention, provided that it accomplishes the above-stated objectives. One of ordinary skill in the art will appreciate that the mobile general store 100 as shown in the FIGS. are for illustrative purposes only, and that many other sizes and shapes of the mobile general store 100 are well within the scope of the present disclosure. Although the dimensions of the mobile general store 100 are important design parameters for user convenience, the mobile general store 100 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile general store truck for purchasing items, the mobile general store truck comprising:
a variety of goods for purchase by customers at a POS with said mobile general store truck;
wherein said variety of goods are selected from a group consisting of food items, beverages, tobacco, and household items;
wherein said variety of goods are accessible at a scheduled location at a scheduled time;
wherein said mobile general store truck is a mobile shop comprising a drivable truck; and
further wherein said mobile general store truck having an interior space for physical shopping of said variety of goods by the customers.

2. The mobile general store truck of claim 1, wherein said mobile general store truck regularly changes geographic locations.

3. The mobile general store truck of claim 2, wherein said mobile general store truck having an exterior surface including a plurality of digital icons configured to indicate said variety of goods sold by said mobile shop.

4. The mobile general store truck of claim 3, wherein said exterior surface having a website URL for accessing a website for ordering said variety of goods sold by said mobile shop.

5. The mobile general store truck of claim 4, wherein said exterior surface having a digital display disposed on said exterior surface for displaying said ordered items of said variety of goods sold by said mobile store and a total price of said ordered items.

6. The mobile general store truck of claim 5, wherein said digital display having a menu display for accepting a payment for said ordered items.

7. The mobile general store truck of claim 6, wherein said exterior surface having a QR code for scanning by an imaging device and redirecting the customer to a website hosted on a website URL, and further wherein said QR code is encoded with said website URL.

8. The mobile general store truck of claim 7, wherein said exterior surface having a card slot for accepting a payment card for purchasing said ordered items.

9. The mobile general store truck of claim 8, wherein said payment card is selected from a group consisting of a credit card and a debit card.

10. The mobile general store truck of claim 9, wherein said exterior surface having a window for passing said ordered times from said interior space to the customer.

11. The mobile general store truck of claim 1, wherein said mobile general truck store is an autonomously-operated mobile general truck.

12. The mobile general store truck of claim 1, wherein said mobile general truck store is a self-driving truck.

13. A mobile general store truck for purchasing items, the mobile general store truck comprising:
a variety of goods for purchase by customers;
wherein said variety of goods are selected from a group consisting of food items, beverages, tobacco, and household items;
wherein said variety of goods are accessible at a scheduled location at a scheduled time;
wherein said mobile general store truck is a mobile shop comprising a drivable truck;
wherein said mobile general store truck having an interior space for physical shopping of said variety of goods by the customers; and
further wherein said purchase comprising a POS purchase or a vending purchase at said mobile general store truck.

14. A mobile general store truck for purchasing items, the mobile general store truck comprising:
a variety of goods for purchase by customers;
wherein said variety of goods are selected from a group consisting of food items, beverages, tobacco, and household items;
wherein said variety of goods are accessible at a scheduled location at a scheduled time;
wherein said mobile general store truck is a mobile shop comprising a drivable truck;
wherein said mobile general store truck having an interior space for physical shopping of said variety of goods by the customers; and
wherein said purchase selected from a group consisting of a POS purchase at said mobile general store truck, a vending purchase at said mobile general store truck, and an online purchase order transmitted to said mobile general store truck;
wherein said mobile general store truck receives said online purchase order wirelessly from an end user device; and
further wherein said end user device is selected from a group consisting of a smartphone, a laptop, a smartwatch, a PDA, and a tablet.

15. The mobile general store truck of claim 14 further comprising a profile database configured to save profiles and information of said purchases of said mobile general store truck.

16. The mobile general store truck of claim 15, wherein said exterior surface having a website URL for accessing a website for ordering said variety of goods sold by said mobile shop.

17. The mobile general store truck of claim 16, wherein said exterior surface having a digital display disposed on said exterior surface for displaying said ordered items of said variety of goods sold by said mobile store and a total price of said ordered items.

18. The mobile general store truck of claim 17, wherein said exterior surface having a card slot for accepting a payment card for purchasing said ordered items.

19. The mobile general store truck of claim 18, wherein said exterior surface having a window for passing said ordered times from said interior space to the customer.

20. The mobile general store truck of claim 19, wherein said mobile general truck store is an autonomously-operated mobile general truck.
